(19) United States
(12) Patent Application Publication
(10) Pub. No.: US 2006/0041847 A1
(43) Pub. Date: Feb. 23, 2006

(54) Paged graphical user interface

(76) Inventor: Wai-Lin Maw, Boise, ID (US)

Correspondence Address: WAI-LIN MAW, 7843 FOX TAIL WAY, BOISE, ID, 83709, US

(21) Appl. No.: 11/204,234

(22) Filed: Aug. 15, 2005

Related U.S. Application Data
(60) Provisional application No. 60/603,715, filed on Aug. 23, 2004.

(51) Int. Cl. G06F 3/00

(52) U.S. Cl. 715/793

(57) ABSTRACT

A graphical user interface where layers of visual information are arranged like the pages in a stack of sheets of paper. Mechanisms, which resemble an actual person navigating through the stack of pages, to turn the pages one at a time, and to hold up the whole stack of pages by their corners and navigate forward and backward through the pages, are provided. Once in either mode, the current top page displayed in full intensity disappears and the potential page of interest is displayed in a silhouette, where it is displayed in full intensity once the user decides to make it the current page. A designated activation region, resembling a curled up page corner in the preferred embodiment, captures the actions of a pointer and initiates the navigation process accordingly.

### CROSS REFERENCE TO RELATED APPLICATIONS

This application claims the benefit of provisional patent application “Paged Graphical User Interface” Serial No. U.S. 60/603,715 filed on Aug. 23, 2004.

### BACKGROUND

1. Field of Invention

The present invention will provide a graphical user interface, which is more space efficient than the traditional windowed graphical user interface. It is most beneficial for devices with smaller displays to intuitively display information in a limited screen space.

2. Discussion of Prior Art

The most widely used graphical user interface (GUI) is the windowed GUI where different applications are presented in overlapping style windows. Not only the user can switch between the opened applications with ease, but she can also arrange the windows so that desired portions of other applications are visible while working on one application. This makes the task of working on two or more applications, or referring to the information on one application while working on another very intuitive and efficient.

While the windowed GUI works well on average screen sizes and resolutions, the same principle design elements that are advantages when applied to computer displays, which it is primarily designed for, become disadvantages when applied to displays that are significantly lesser in size or resolution. For smaller displays on devices such as desktop and mobile phones, sprinkler controls, hospital monitors, security system control units, and thermostat control units, the amount of extra space required by the title bars and overlapping windows can take up a disproportionately large percentage of the display.

Variants of the windowed GUI have been invented. Some employ three-dimensional graphics for improved presentation or maneuverability, while others offer a stack of screens that can be navigated by the use of tabs similar to the tabs in an actual notebook.

All of the approaches in the prior art, including the windowed GUI, require part of the screen for displaying the navigation mechanisms. A three-dimensional GUI typically requires more screen space and resolution than a two-dimensional GUI, in order to keep the elements displayed further in depth to be legible to a reasonable extent. A three-dimensional GUI clearly is not a practical choice for a display that is inadequate in size or resolution for a two-dimensional GUI. Even though the notebook style tabs do not take as much screen space as a three-dimensional GUI, it still doesn't allow making use of the available screen space to the fullest extent possible.

### OBJECTS AND ADVANTAGES

One object of the invention is to efficiently make use of the screen space where the full extent of the display is available for displaying information, and to bring up the navigation mechanisms only on demand.

Another object is to provide an intuitive navigation method mimicking a common task that many users are already familiar with.

Yet, another object is to provide a navigation mechanism that allows the user to reference information on another screen with ease.

### SUMMARY

The present invention arranges layers of information, or screens from multiple applications, in the way sheets in a stack of pages are arranged, and provides intuitive mechanisms to navigate through the pages. The navigation is primarily executed by means of a pointer driven by a pointing device, on the graphical user interface. A visual illustration that mimics the physical process of navigating through a stack of pages is created during these processes to provide a greater intuitive feel.

The primary navigation aid is the shape of an upturned page corner, or a curled up edge of a page at its extremity, that remains invisible until the user moves the pointer within the specified limits of the page corner.

Once within the region, the user can drag the page corner towards the center of the page in a manner one would peel off, or turn over a page in a book.

Once a threshold is reached during the dragging process, the page turns over to the next page, just as a leaf of page in a stack of pages is flipped over. If the user releases the dragging action before reaching the threshold, the current page is redisplayed, similar to the manner where a leaf of page returns back to its original position if the user lets go off the corner of the page before turning it beyond a threshold.

During the process of turning the page over, the title of the page behind scrolls out along with the increasing shape of the dragged page corner to provide a visual clue of the page behind. The information on the page behind the current page is also displayed in a silhouette, in adjustable degrees, to allow the user to reference the information on the page behind.

A navigation mechanism that allows the user to hold up a number of pages from a corner and flip back and forth is also provided. In addition, a page list menu is also provided to allow the user to quickly jump from once page to another, or to reorganize the position of the pages within the stack of pages.

### DRAWINGS—FIGURES

FIG. 1—is the page stack structure in its initial state

FIG. 2—is the display in neutral state with the pointer positioned in the middle of the screen

FIG. 3—is the state of the display after the pointer is moved into the primary activation region

FIG. 4—is the state of the display after entering the page-turn mode

FIG. 5—is the state of the display as the user drags the primary activation region towards the middle of the screen

FIG. 6—is the state of the display after the page corner is dragged beyond the page turning threshold

FIG. 7—is the state of the display after the dragged page corner is releases before reaching the page turning threshold

FIG. 8—is the state of the page stack after the user turns over the first page in sequence and brings the second page in sequence to the forefront

FIG. 9—is the state of the display after the user enters the page-hold mode

FIG. 10—is the state of the display after the user selects the secondary activation region for turning one more page

FIG. 11—is the page list menu for navigating or rearranging the pages in the stack

FIG. 12—is state of the display after the user selects the second page in sequence from the page list menu

FIG. 13—is an alternative embodiment with multiple primary activation regions

### DRAWINGS—LIST OF REFERENCE NUMERALS

20A—Initial state of the page stack

20B—State of the page stack after the second page in sequence becomes the top page

22—Pointer

24A—Primary activation region

24B—Secondary activation region

26—The total number of pages in the stack

28A—Information on the first page in sequence

28B—Information on the second page in sequence

29—Page displayed in a silhouette

30—Title of the next page in sequence

32—Page turning threshold

34—Page number of current page on top

40—Page list menu

### DETAILED DESCRIPTION—PREFERRED EMBODIMENT

An operating system (not shown) stores and manipulates various screens in memory in the fashion that a person organizes a stack of sheets and turns the pages to arrive at the desired page, or hold a number of pages up for quick reference. The operating system (OS), interprets the input from a mouse or an equivalent input device to navigate through the stack of pages by means of a pointer or a cursor. The bottom right corner of the top page, displayed on a display, is designated as an activation region for page navigation.

The system adopts page-turn and page-hold modes to manage the sheets in the page stack. The page-turn mode mimics the action of the user turning a page from its corner. The page-hold mode mimics the action of the user holding up a number of pages without completely turning over to a new page to reference information on different pages.

### OPERATION OF THE INVENTION—PREFERRED EMBODIMENT

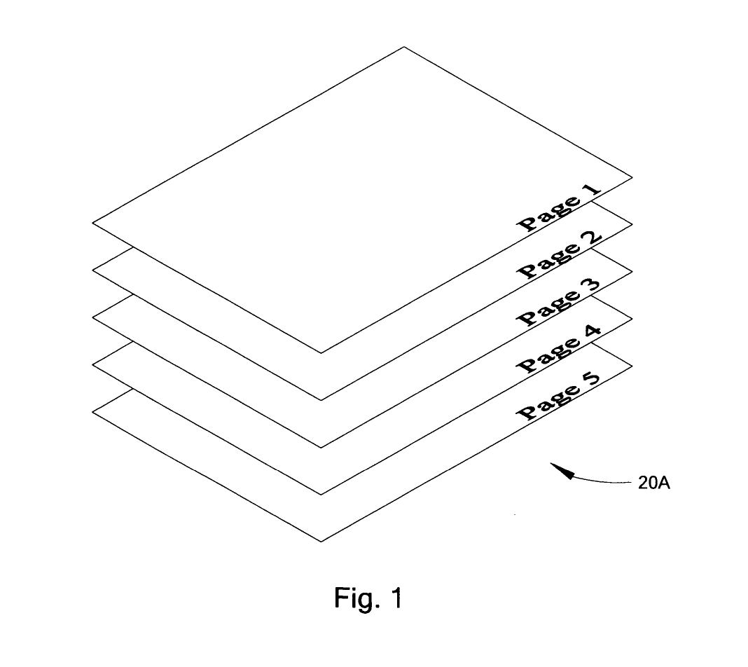

FIG. 1 shows the initial state of the page stack 20A as stored in memory. Pages are logically numbered from top to bottom. They are labeled to aid the reader in following the navigation process, but do not necessarily reflect the absolute position of the pages in the stack.

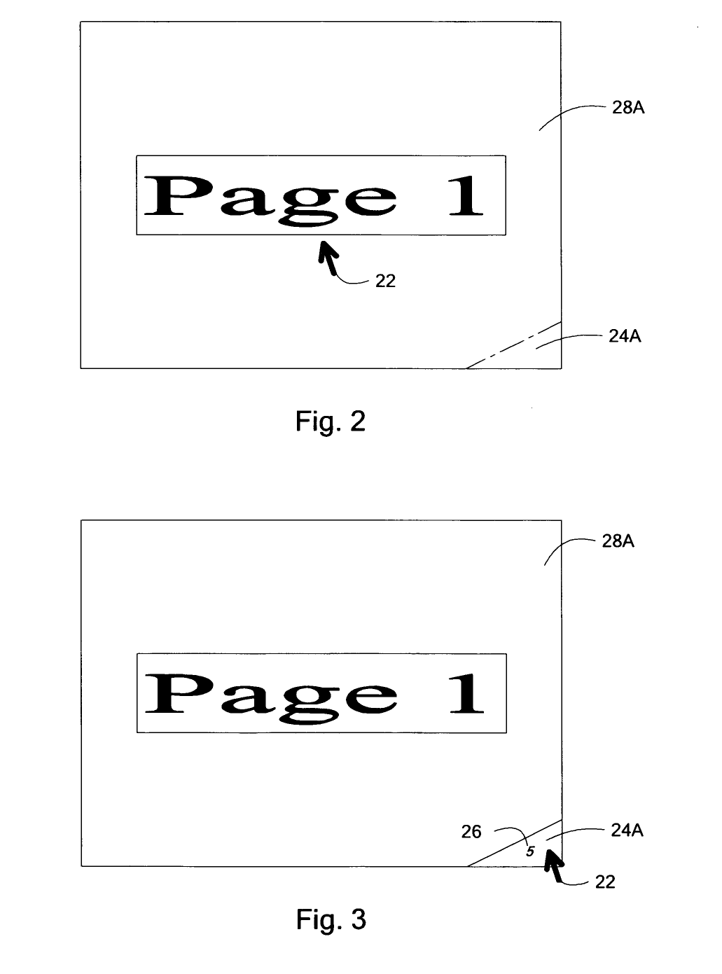

FIG. 2 shows the information on the first page in sequence 28A, which is the current top page displayed in full view, or in full intensity, in neutral state. The primary activation region 24A in the shape of a page corner at the bottom right corner of the page, which is shown in a phantom line is not actually visible at this stage but can be setup to be displayed in certain intensity.

FIG. 3 shows the state of the screen as the pointer 22 is moved into the primary activation region 24A. As the pointer 22 enters the primary activation region 24A, the boundaries of the primary activation region 24A, and the total number of pages in the stack 26 are displayed inside.

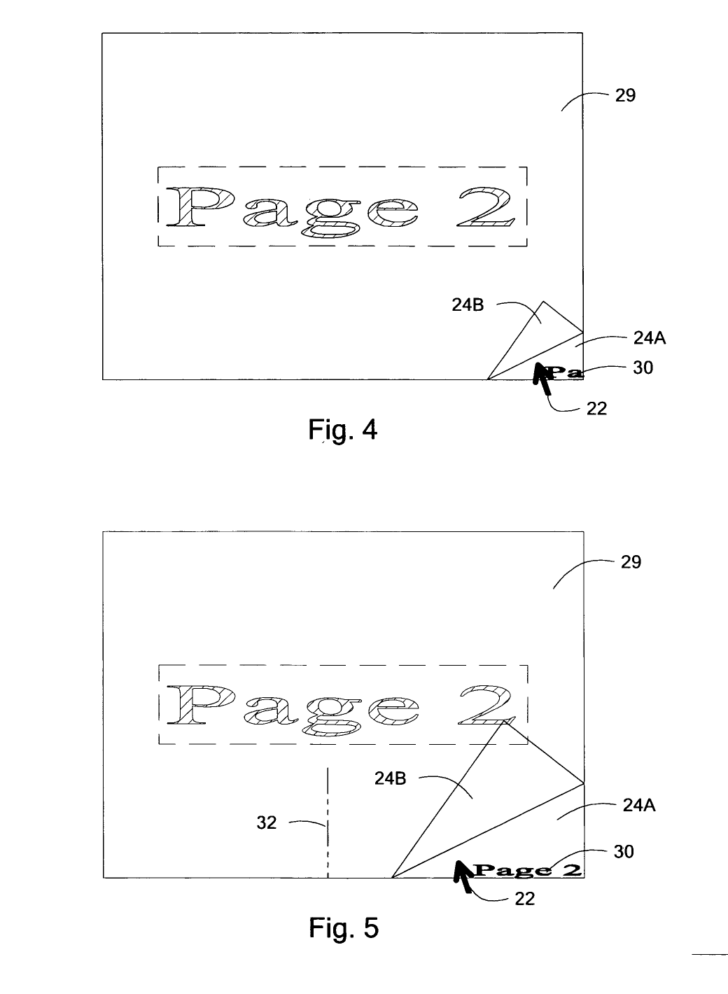

FIG. 4 shows the state of the display after the user clicks, a single left click, in the primary activation region 24A. As soon as the user clicks and holds down in the primary activation region 24A, the system enters the page-turn mode and the secondary activation region 24B in the shape of an upturned page corner is displayed. The information on the first page in sequence 28A, displayed as the original top page as shown in FIG. 3, disappears and the information on the next page in sequence is displayed in a silhouette 29. The intensity and the level of detail of the silhouette can be adjusted to various degrees. At the same time, the title of the next page in sequence 30, now displayed in a silhouette 29, scrolls out from the edge of the primary activation region 24A.

FIG. 5 shows the progressive changes as the user drags the pointer 22 positioned inside the primary activation region 24A further to the left. The sizes of the primary activation region 24A, and secondary activation region 24B grow proportionally as the pointer 22 approaches the page turning threshold 32. The title of the next page in sequence 30 also scrolls further out in sync with the movement of the pointer 22.

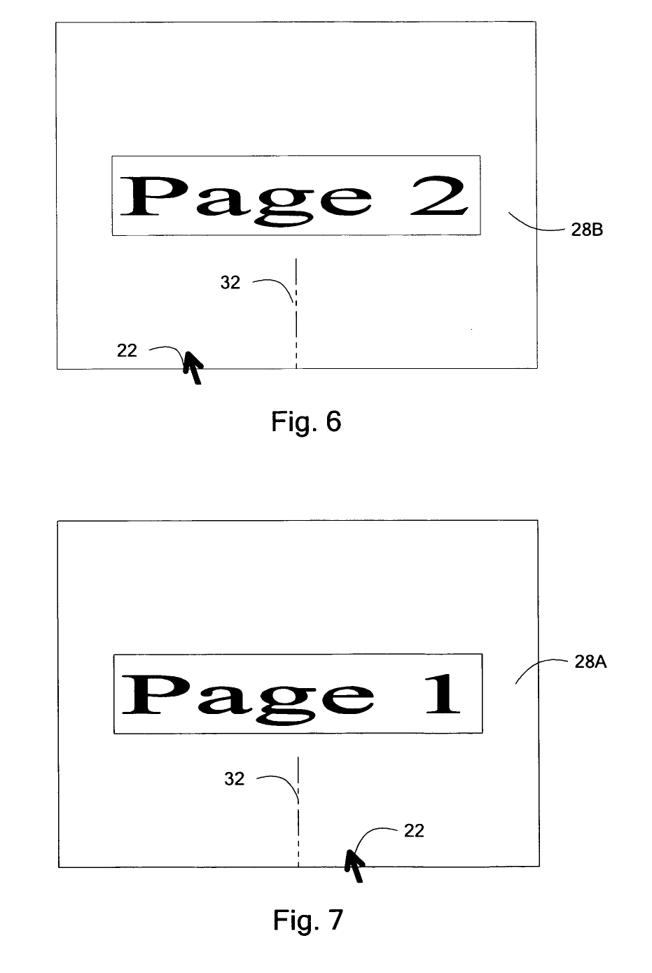

FIG. 6 shows the pointer 22 moving past the page turning threshold 32, and bringing the next page in sequence, which was previously displayed in a silhouette 29 in FIG. 5, to the forefront, or to the top of the page stack. The information on the next page in sequence 28B is now displayed in full view. The previous top page is now moved to the bottom of the page stack.

FIG. 7 shows the display reverting back to its original state when the user cancels the dragging action by releasing the mouse before the pointer 22 reaches the page turning threshold 32. The screen reverts back to the state before the dragging action took place, and, redisplays the previous top page 28A in full view.

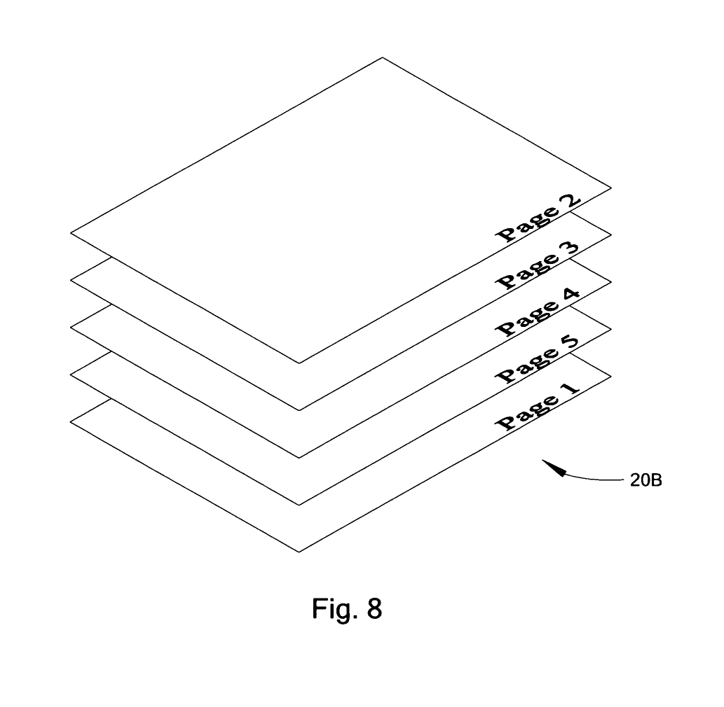

FIG. 8 shows the state of the page stack 20B after the second page in sequence becomes the top page, and is displayed in full view as shown in FIG. 6.

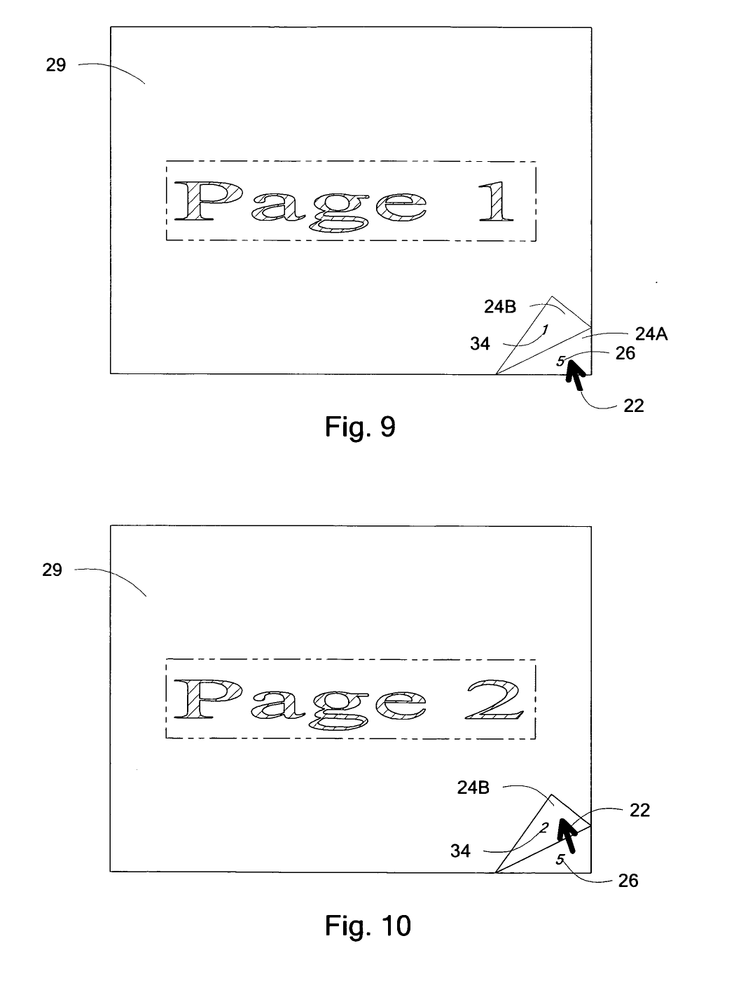

FIG. 9 shows the state of the display after the user double clicks in the primary activation region 24A and enters the page-hold mode, where the operating system mimics the action of a person physically holding a stack of pages by their corners without completely turning over to another page, and flipping forward and backward through the stack to reference information on other pages.

Once the user enters the page-hold mode, the secondary activation region 24B is displayed, and the information on the first page in sequence 28A, the current top page in the stack, is now displayed in a silhouette 29. The number of the current page on top 34 is displayed inside the secondary activation region 24B, and the total number of pages in the stack 26 is displayed inside the primary activation region 24A. To advance or flip up one page, the user would click once in the secondary activation region 24B, and to release or flip down one page, the user would click once in the primary activation region 24A.

FIG. 10 shows the state of the display after the user clicks once on the secondary activation region 24B. Double clicking on the secondary activation region 24B makes the page, currently displayed in silhouette 29, the current page and displays it in full intensity. Double clicking on the primary activation region 24A exits the page-hold mode, and reverts the GUI back to its original state where the last top page is redisplayed in full view.

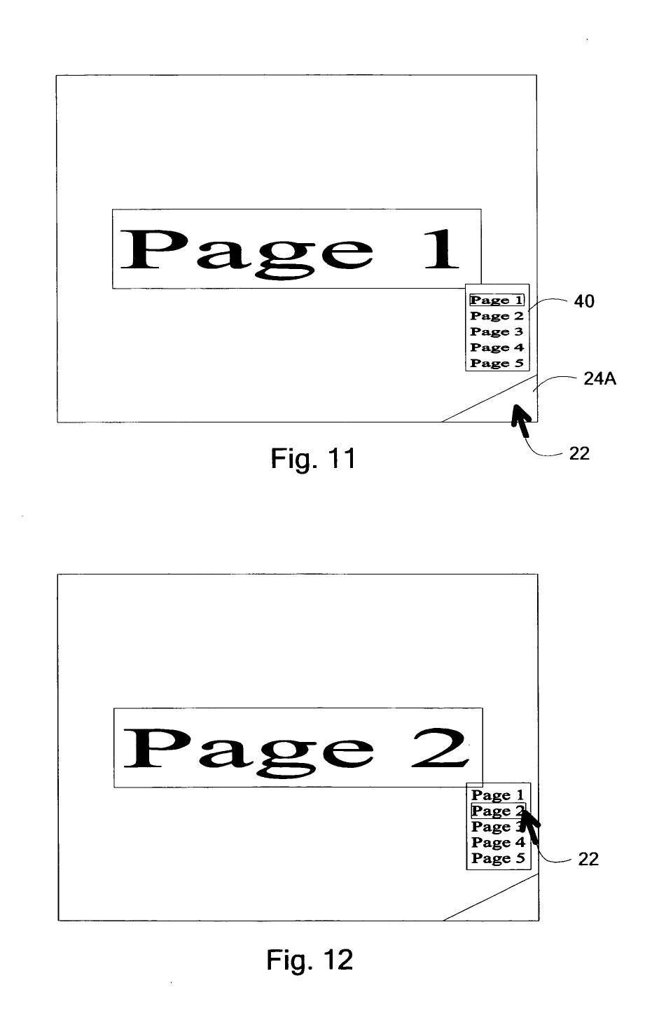

FIG. 11 shows the page list menu 40 after the user right clicks in the primary activation region 24A while in the neutral state as shown in FIG. 2.

FIG. 12 shows the state of the display after the user selects the second page in sequence, bringing it to the forefront. All pages above the selected page are moved to the bottom of the page stack in the existing order.

Alternatively, the user can drag and drop the pages in the page list menu 40 to reorganize the pages in the page stack.

### DESCRIPTION AND OPERATIONS—ALTERNATIVE EMBODIMENTS

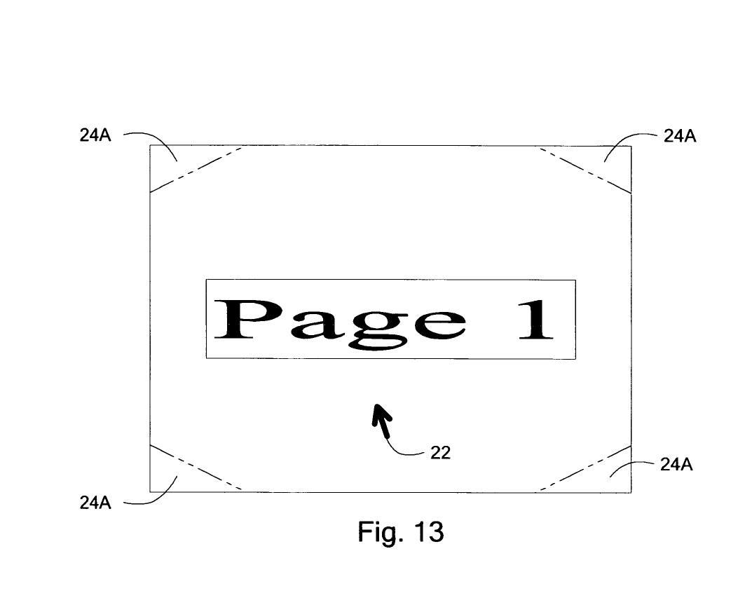

FIG. 13 shows an alternative embodiment with multiple primary activation regions 24A.

The navigation process can be executed from any of the primary activation regions 24A, and the next page to be displayed is selected according to the activation region selected.

### CONCLUSION, RAMIFICATIONS AND SCOPE OF INVENTION

The reader will see that the present invention provides a means to display layers of information in a space efficient manner.

While the above description contains many specifications, these should not be construed as a limitation of the scope of the invention, but rather as an exemplification of a few embodiments thereof.

Different embodiments with several activation regions that work in more than one direction can also be implemented. An impression of the edge of a page turned up can also be used instead of a page corner, to serve as an activation region. Other navigation mechanisms to add, delete, move, and resize the pages can also be added without departing from the scope of the current invention.

Accordingly, the scope of the invention should be determined not by the embodiments illustrated, but by the appended claims and their legal equivalents.

What is claimed is:

1. A graphical user interface comprising;
a display;
a pointer;
an input device;
a means to interactively operate said display, said pointer, and said input device;
a plurality of screens stored as a virtual stack of pages, wherein the topmost page is selected and displayed as the current page; and
a corner of said current page designated as an activation region wherein a drag action of said activation region with said pointer across said display replaces said current page with the next page in sequence.

2. The graphical user interface according to claim 1 wherein said activation region is further defined as the first activation region, and positioned at the bottom right corner of said current page.

3. The graphical user interface according to claim 2 wherein said first activation region is in the shape of a triangular page corner.

4. The graphical user interface according to claim 3 wherein an outline of said first activation region, and the total number of pages are displayed when said pointer is moved inside said first activation region.

5. The graphical user interface according to claim 3 whereby a click and hold action enters the page-turn mode wherein:
said first activation region is set into an active state; and
a curled up page corner is displayed when said first activation region is in an active state.

6. The graphical user interface according to claim 5 wherein dragging said first activation region in an active state across said display in said page-turn mode:
temporarily hides said current page;
displays said next page in sequence in a silhouette;
proportionally increases the size of said curled up page corner; and
proportionally scrolls out the title of said next page in sequence.

7. The graphical user interface according to claim 6 further comprising a threshold in said page-turn mode wherein:
said pointer moving past said threshold during said drag action replaces said current page with said next page in sequence;
releasing said drag action before said pointer reaching said threshold redisplays said temporarily hidden current page and sets said display to the state before said drag action was initiated; and
exits said page-turn mode once a page is selected as the current page.

8. The graphical user interface according to claim 3 whereby a double click on said first activation region enters the page-hold mode wherein:
a second activation region is displayed:
said first and second activation regions are set into an active state;
clicking once on said second activation region displays the next page in sequence in a silhouette;
clicking once on said first activation region displays the previous page in sequence in a silhouette;
double clicking on said second activation region selects said page displayed in a silhouette as the current page and displays it in full intensity, and exits said page-hold mode; and
double clicking on said first activation region exits said page-hold mode and reverts said display back to the state before said page-hold mode was entered.

9. The graphical user interface according to claim 3 further comprising a page list menu wherein:
a right click on said first activation region makes said page list menu visible; and
a click on an entry in said page list menu selects the corresponding page as the current page and displays it in full intensity, and makes said page list menu invisible.

10. A graphical user interface comprising:
a pointer;
a set of information layers virtually arranged in sequence;
an information layer selected and displayed as the current information layer;
one or more activation regions positioned at the extremities of said current information layer;
a means to activate an activation region when the user executes a click and hold action inside said activation region;
a means to drag said activation region across said display to remove said current information layer, and display the next information layer in sequence as the current information layer; and
a first and second activation regions whereby double clicking on said first activation region activates said first and second activation regions, and clicking on said first and second activation regions temporarily displays the respective information layers in sequence.

11. The graphical user interface according to claim 10 further comprising a threshold wherein:
reaching said threshold during said drag action of an activation region replaces said current information layer with the next information layer in sequence in accordance with the original position of said activation region and the direction of said drag action; and
releasing said drag action before reaching said threshold restores said current information layer in its original state.

12. The graphical user interface according to claim 11 wherein said drag action of said activation region mimics the action of a person turning a sheet in a stack of sheets to reveal another sheet in said stack of sheets.

13. The graphical user interface according to claim 10 wherein the title of said next information layer in sequence is displayed in proportion to said drag action of said activation region.

14. The graphical user interface according to claim 10 wherein:
the process of single clicking on said second activation region displays the next information layer in sequence;
the process of single clicking on said first activation region displays the previous information layer in sequence;
the process of double clicking on said second activation region selects the next information layer in sequence as the current information layer; and
the process of double clicking on said first activation region redisplays the information layer that was originally selected as the current information layer.

15. The graphical user interface according to claim 14 wherein said processes of navigating through a stack of information layers mimics the action of a person holding up a stack of sheets and flipping the sheets forward and backwards while continuing to hold up said stack of sheets.

16. The graphical user interface according to claim 10 further comprising a menu containing a plurality of titles of said information layers, wherein clicking a title in said menu selects the corresponding information layer as the current information layer.

17. An interactive display method comprising the steps of:
providing a pointer;
arranging a plurality of information layers in a virtual stack;
selecting one layer as the current layer;
maintaining a neutral state where a navigation action can be executed; and
navigating through said virtual stack with said pointer mimicking the action of a person navigating through a stack of sheets.

18. The interactive display method according to claim 17 wherein said step of navigating through said virtual stack further comprising the steps of:
providing a visual illustration of said pointer lifting up an edge of said current information layer, peeling it off to make it disappear, and temporarily revealing the next information layer in sequence, with a dragging action;
providing a threshold;
selecting said temporarily revealed information layer to be the current information layer, and reverting back to said neutral state when said pointer reaches said threshold during said dragging action of said pointer; and
reverting back to said neutral state where the last said current information layer is redisplayed, when said dragging action of said pointer is cancelled before reaching said threshold.

19. The interactive display method according to claim 17 wherein said step of navigating through said virtual stack further comprising the steps of:
providing a visual illustration of said virtual stack being held up, and browsing through said virtual stack utilizing said pointer without selecting any one of said information layers as the current information layer;
providing an activation region;
revealing the next information layer in sequence when clicked on said activation region;
selecting the revealed information layer as the current layer and reverting back to said neutral state when double clicked on said activation region;
providing another activation region;
revealing the previous information layer in sequence when clicked on said activation region; and
selecting and redisplaying the last current information layer, and reverting back to said neutral state when double clicked on said activation region.

20. The interactive display method according to claim 17 wherein said step of navigating through said virtual stack further comprising the steps of:
providing a menu of the list of information layers in said virtual stack; and
jumping to an information layer corresponding to the entry selected with said pointer from said menu of the list of information layers in said virtual stack.
